(19) United States
(12) Patent Application Publication
(10) Pub. No.: US 2004/0017493 A1
(43) Pub. Date: Jan. 29, 2004

(54) Resolution conversion method and pixel data processing circuit for single-plate-type color-image sensor

(75) Inventors: Hiroshi Daiku, Kawasaki (JP); Shigeru Nishio, Kawasaki (JP); Asao Kokubo, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU, LTD.

(21) Appl. No.: 10/613,124

(22) Filed: Jul. 7, 2003

(30) Foreign Application Priority Data
Jul. 25, 2002 (JP) 2002-216848
Oct. 30, 2002 (JP) 2002-316250

(51) Int. Cl. H04N 5/335

(52) U.S. Cl. 348/272

(57) ABSTRACT

A resolution conversion method and a pixel data processing circuit for a single-plate type color image sensor has been disclosed, in which resolution conversion processing and simultaneous processing can be performed with a simple configuration, an image of high sharpness can be obtained without degradation of resolution, and the pixel positions of respective colors coincide with each other. Resolution conversion processing that converts color data of each pixel output from a single-plate-type color-image sensor into data of a predetermined resolution and simultaneous processing that processes the color data so that the pixel positions of respective colors coincide with each other are performed simultaneously in the same circuit.

This application is based upon and claims the benefit of priority from the prior Japanese Patent Application Nos. 2002-216848 and 2002-316250, respectively filed in Jul. 25 and Oct. 30, 2002, the entire contents of which are incorporated herein by reference.

### BACKGROUND OF THE INVENTION

The present invention relates to a resolution conversion method for converting the resolution of pixel data output from an image sensor and an image pickup apparatus equipped with a resolution conversion function. More particularly, the present invention relates to a resolution conversion method for converting the resolution of pixel data output from a single-plate-type color-image sensor that must perform simultaneous processing so that pixel positions of respective colors coincide with each other, and a pixel data processing circuit that converts the resolution of the pixel data from the single-plate-type color-image sensor.

There are two types of color image sensor, a three-plate type (three-tube type) and a single-plate type (single-tube type). A three-plate-type color-image sensor optically separates a projected image into three color images, and the three color images are detected by three image sensors. Therefore, the pixel positions of respective colors coincide with each other. Contrary to this, a single-plate-type color-image sensor is provided with small three color filters arrayed on an image pickup surface, which detect light passing therethrough. Therefore, the pixel positions of respective colors do not coincide with each other.

FIG.1 is a diagram showing a pixel array in a single-plate-type color-image sensor. As shown schematically, plural pixels are arrayed in a two-dimensional manner in groups of a set composed of four pixels, that is, one red (R) pixel, two green (G) pixels, and one blue (B) pixel. The position of each pixel in the array is expressed by coordinates. For example, in the first row and first column, R1, 1 is located, in the fourth row and third column, G3, 4 is located, and in the sixth row and fourth column, B4, 6 is located. In the following description, it is assumed that the pixel array in a single-plate-type color-image sensor has an array shown in FIG.1. However, the present invention is not limited to such an array but is applicable to other arrays.

As shown in FIG.1, the positions of pixels differ from color to color in a single-plate-type color-image sensor and if the color data thereof is directly output without processing, the pixel positions of respective colors will differ from each other. In the case of a three-plate-type color-image sensor, the pixel positions of respective colors coincide with each other, therefore a problem occurs that the pixel portions of color data of the single-plate-type and the three-plate-type color-image sensors do not match with each other if the color data of the single-plate-type color-image sensor is output without processing. To prevent this, a weighting operation is performed on outputs of cells adjacent to each other of each color in the single-plate-type color-image sensor so that the pixel positions of respective colors coincide with each other. As such processing is called simultaneous processing, the term is also used here.

Recently, a solid-state image pickup device has been used as a built-in device in many products such as digital cameras and portable terminals. The solid-state image pickup devices include a CCD type solid-state image pickup device composed of a charge transfer type image sensor and a CMOS type solid-state image pickup device, the image sensor of which is composed of CMOS transistors. The CMOS type image sensor can be manufactured with the same technology as the MOSFET manufacturing process and is expected to be a replacement for a CCD image sensor because it can be driven by a single power source, its power consumption is small, and various signal processing circuits can be mounted on a single chip.

The image sensor, particularly the CMOS type image sensor, has made progress in its resolution and the number of pixels is increasing. However, the number of pixels in a display screen is limited when an image is displayed in a small liquid crystal screen of a cellular phone or the like, therefore, it is necessary to convert the resolution of an image signal output from the image sensor according to the display screen. Moreover, there is a function called a digital zoom that functions in such a way as to display part of an image of high resolution output from the image sensor when the resolution is lowered according to the screen although the image sensor outputs an image of high resolution, as described above, and in this case it is necessary to convert the resolution according to the zooming magnification. In the case of a cellular phone, it is necessary that the image pickup apparatus having the image sensor be provided with the above-mentioned resolution conversion function, that the image pickup apparatus convert the resolution according to the resolution information sent from the cellular phone, and that image data, the resolution of which has been converted, is output to the display device (display).

As described above, there are some cases where the image pickup apparatus that uses a single-plate-type color-image sensor is required to perform resolution conversion processing as well as simultaneous processing. The present invention is applied mainly to such an image pickup apparatus, but is not limited to this.

FIG. 2A to FIG. 2C are diagrams showing conventional configurations of the processing system of a single-plate-type color-image sensor that performs both simultaneous processing and resolution conversion processing. FIG. 2A is an example of a configuration in which a simultaneous processing circuit 13 is provided in a TV camera 11. This configuration example is disclosed, for example, in Japanese Unexamined Patent Publication (Kokai) No. 2001-119705. As shown schematically, through a lens 12, the image of an object 10 is projected on a single-plate-type color-image sensor 13, each pixel of the single-plate-type color-image sensor 13 produces a pixel signal, and the pixel signals are read one by one. Each pixel signal is converted into digital data by an analog-digital (A/D) converter provided in the single-plate-type color-image sensor 13, and is output to the simultaneous processing circuit 13. The simultaneous processing circuit 13 performs a weighting operation on data of pixels adjacent to each other so that the pixel positions of respective colors coincide with each other and outputs its result as pixel data. Thus, in the configuration shown in FIG. 2A, the pixel data output from the image pickup apparatus 13 is image data of high resolution, the pixel positions of respective colors of which coincide with each other. A resolution conversion processing circuit 14 performs resolution conversion processing on such pixel data according to the resolution information directed from a display 20 and outputs its result to the display 20. Therefore, the pixel data output to the display 20 is image data appropriate to the display 20 and the display 20 displays the input image data without processing.

FIG. 2B is an example of a configuration in which a thinning processing circuit 15 is provided within the TV camera 11. The thinning processing circuit 15 outputs only part of the data of each pixel output from the single-plate-type color-image sensor 13 according to the resolution information directed by the display 20. The processing that the thinning processing circuit 15 can perform is only simple thinning processing in which the resolution is converted to 1/n, where n is a natural number.

FIG. 2C shows a configuration in which resolution conversion and simultaneous processing are not carried out inside but outside the TV camera 11. As shown schematically, the pixel data that the TV camera 11 outputs undergoes a change in resolution in a resolution conversion processing circuit 17 according to the resolution information directed by the display 20, and after undergoing simultaneous processing in a simultaneous processing circuit 18 so that the pixel positions of respective colors coincide with each other, it is output to the display 20.

FIG. 3A and FIG. 3B are diagrams illustrating the case where the 1-to-⅓ resolution conversion and simultaneous processing are performed on the pixel data of the single-plate-type color-image sensor 13 shown in FIG.1 with the configuration shown in FIG. 2C. FIG. 3A shows the pixel data of each color after the resolution conversion processing and the operation expressions, and FIG. 3B shows the pixel data after the simultaneous processing and the operation expressions. As shown in FIG. 3A, the pixel array is divided into 6×6 blocks, operations are performed on each color according to the operation expressions shown schematically, and R data is obtained at the position denoted by a triangle, G data, at the two positions denoted by a circle and a double circle, and the B data, at the position denoted by a square. In the next simultaneous processing, if interest is focused on the position denoted by the triangle, operations are performed on the data of pixels adjacent to each color according to the operation expressions shown schematically and the pixel data after the simultaneous processing can be obtained at the positions denoted by the triangle, circle and square. By performing such processing on the positions denoted by two circles and a square, as well as the position denoted by a triangle, four sets of data of the three colors are obtained in each block.

FIG. 4 is a diagram illustrating the case where the 1-to-⅔ resolution conversion is performed on the pixel data of the single-plate-type color-image sensor 13 shown in FIG. 1 with the configuration shown in FIG. 2C. Weighting operations are performed on the data of pixels adjacent to each other according to the operation expressions shown schematically and R data is obtained at the position denoted by a triangle, G data, at the two positions denoted by a circle and a double circle, and B data, at the position denoted by a square.

FIG. 5 shows the pixel data and operation expressions after the simultaneous processing is performed on the pixel data that has undergone the above-mentioned 1-to-⅔ resolution conversion. In this simultaneous processing, if interest is focused on the position denoted by the triangle, operations are performed on data of pixels adjacent to each other according to the operation expressions shown schematically and the pixel data after the simultaneous processing can be obtained at the positions denoted by the triangle, circle and square. By performing such processing on the positions denoted by two circles and a square, as well as the position denoted by a triangle, four sets of data of the three colors are obtained in 3×3 blocks.

Conventionally, as described above, the resolution conversion processing and the simultaneous processing have been performed in various processing systems and in a time-series manner, as shown in FIGS. 2A to 2C. Therefore, circuits for resolution conversion processing and simultaneous processing are required, respectively, resulting in a large amount of hardware, on the whole. For example, when the 1-to-⅓ resolution conversion processing and the simultaneous processing shown in FIG. 3A and FIG. 3B are performed simultaneously, the resolution conversion processing is performed first. At this time, a line memory for at least for five lines is necessary in order to prevent image information from being lost. Moreover, two line memories are necessary for the subsequent simultaneous processing.

Still moreover, the pixel data of each color after the simultaneous processing loses its sharpness because information on adjacent 12×12 pixels is mixed, and at the same time the pixel positions of respective colors R, G, and B do not coincide with each other. In other words, the simultaneous processing is not performed completely, therefore, an image is displayed in which the pixel positions of respective colors differ from each other, resulting in a problem that the resolution is degraded.

### SUMMARY OF THE INVENTION

It is the object of the present invention to solve such a problem and to realize a resolution conversion method and a pixel data processing circuit for a single-plate-type color-image sensor, in which resolution conversion processing and simultaneous processing can be performed with a simple configuration, a high sharpness can be obtained without degradation of resolution, and the pixel positions of respective colors coincide with each other.

FIG. 6 is a diagram showing the fundamental configuration of the image pickup apparatus of the present invention.

In order to realize the above-mentioned object, the resolution conversion method and the pixel data processing circuit for a single-plate-type color-image sensor of the present invention are designed so that the resolution conversion processing and the simultaneous process are performed simultaneously in a circuit 31, as shown in FIG. 6. In concrete terms, the resolution conversion processing and the simultaneous processing are performed in one time weighting operation of the data of pixels of each color adjacent to each other (pixels including each pixel and neighboring pixels adjacent to the pixel). The resolution conversion/simultaneous processing circuit 31 is provided integrally with the TV camera 11.

According to the resolution conversion method and the pixel data processing circuit for a single-plate-type color-image sensor of the present invention, the size of the hardware can be reduced because the resolution conversion processing and the simultaneous processing are performed simultaneously in the same hardware. Moreover, as operations are performed on the data before thinning of the peripheral necessary information, data of high sharpness can be obtained without degradation of the resolution and the pixel positions of respective colors can be made to coincide with each other with simple operation expressions.

When the resolution of the pixel data to be output is converted according to the resolution information from the display, plural processes to convert into different resolutions, that is, plural operation expressions need to be stored in advance, and some of the plural operation expressions are selected and executed according to the external direction.

### BRIEF DESCRIPTION OF THE DRAWINGS

The features and advantages of the invention will be more clearly understood from the following description taken in conjunction with the accompanying drawings in which:

FIG. 1 is a diagram showing an example of a pixel array of a single-plate-type color-image sensor;

FIGS. 2A to 2C are diagrams showing conventional examples of configuration of a processing system of an image pickup apparatus having a single-plate-type color-image sensor;

FIGS. 3A and 3B are diagrams illustrating conventional 1-to-⅓ resolution conversion and simultaneous processing;

FIG. 4 is a diagram illustrating conventional 1-to-⅔ resolution conversion;

FIG. 5 is a diagram illustrating the conventional simultaneous processing after the 1-to-⅔ resolution conversion;

FIG. 6 is a diagram showing the fundamental configuration of the image pickup apparatus of the present invention;

FIG. 7A and FIG. 7B are diagrams showing the configuration of the image pickup apparatus in the embodiments of the present invention;

FIG. 8 is a diagram illustrating the 1-to-⅓ resolution conversion and simultaneous processing in the embodiments;

FIG. 9A and FIG. 9B are diagrams illustrating the 1-to-⅔ resolution conversion and simultaneous processing in the embodiments;

FIG. 10 is a diagram illustrating the 1-to-¼ resolution conversion and simultaneous processing in the embodiments;

FIG. 11 is a diagram illustrating the 1-to-½ resolution conversion and simultaneous processing in the embodiments; and

FIG. 12 is a diagram illustrating the 1-to-1 resolution conversion (no resolution conversion) and simultaneous processing in the embodiments.

### DESCRIPTION OF THE PREFERRED EMBODIMENTS

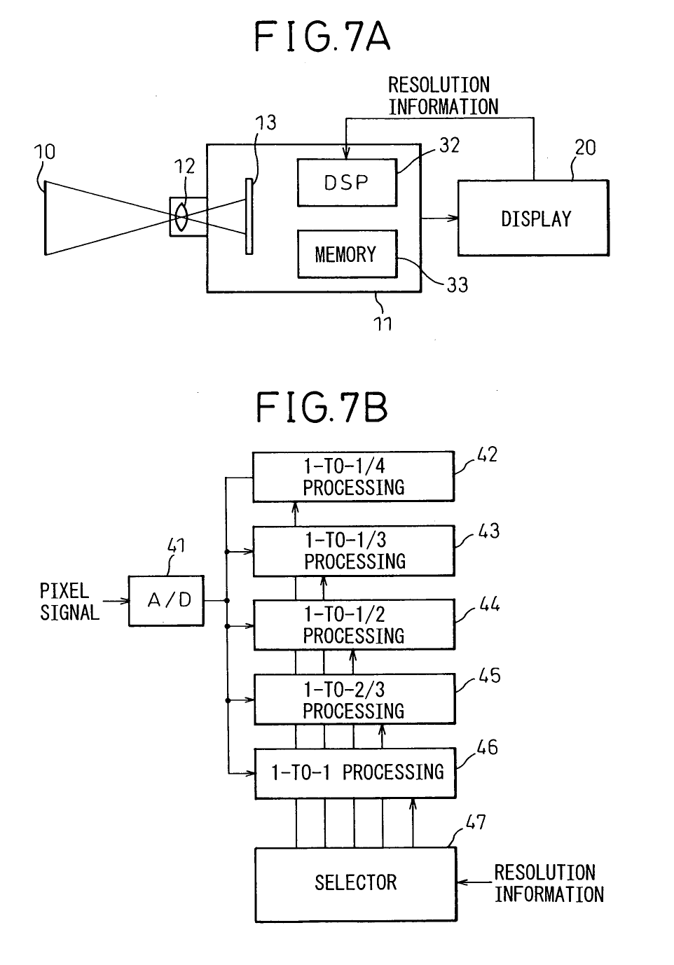

FIG. 7A is a diagram showing the configuration of the image pickup apparatus (TV camera) in the embodiments of the present invention. As shown in FIG. 7A, a TV camera 11 is provided with an operation unit consisting of a digital signal processing (DSP) device 32 and a memory 33.

FIG. 7B is a diagram showing the configuration of the operation unit, in which five kinds of operation units 42 to 46 processing pixel data output from an A/D converter 41 of a single-plate-type color-image sensor 13 are provided and a selector 47 selects and activates one of the operation units in accordance with the resolution information input from a display 20. The five operation units include a 1-to-¼ resolution conversion processing unit 42, a 1-to-⅓ resolution conversion processing unit 43, a 1-to-½ resolution conversion processing unit 44, a 1-to-⅔ resolution conversion processing unit 45 and a 1-to-1 resolution conversion processing unit 46. The 1-to-1 resolution conversion processing unit 46 does not convert resolution but performs only the simultaneous processing. The processing in each operation unit is described below.

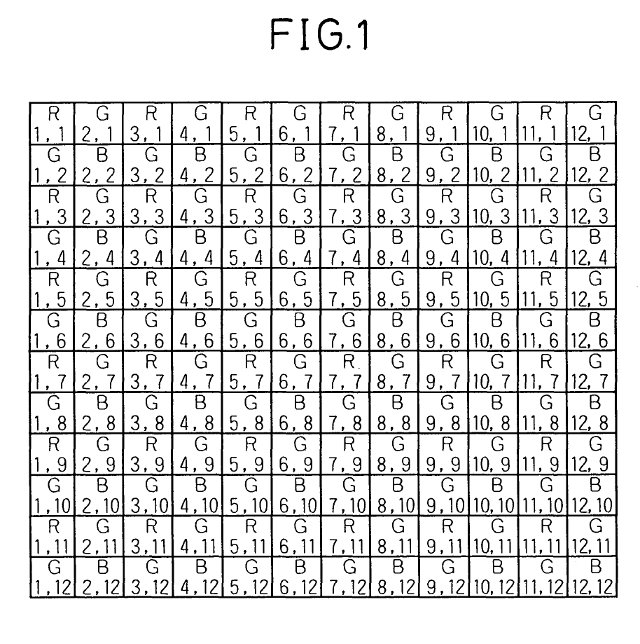

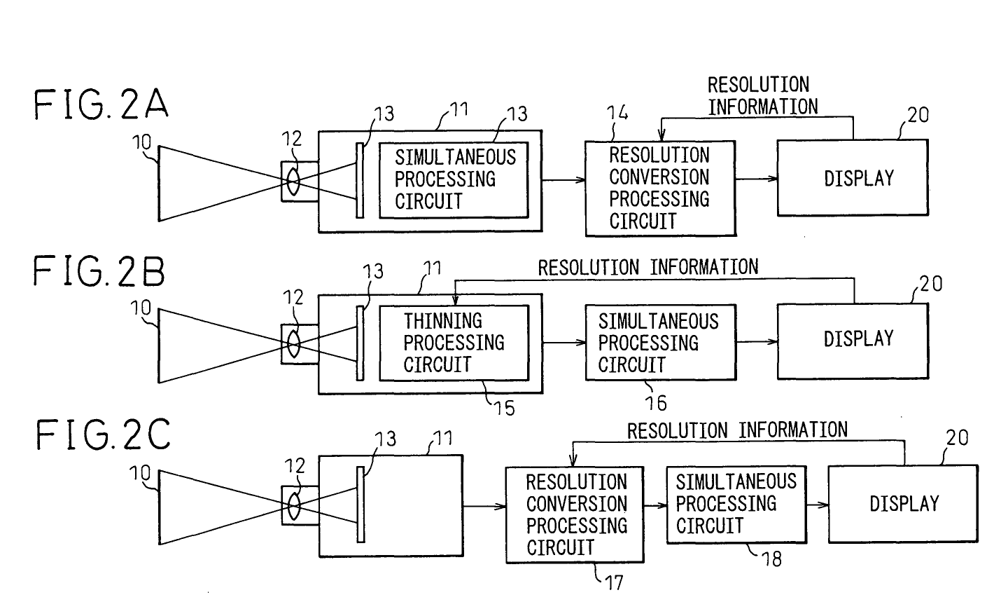

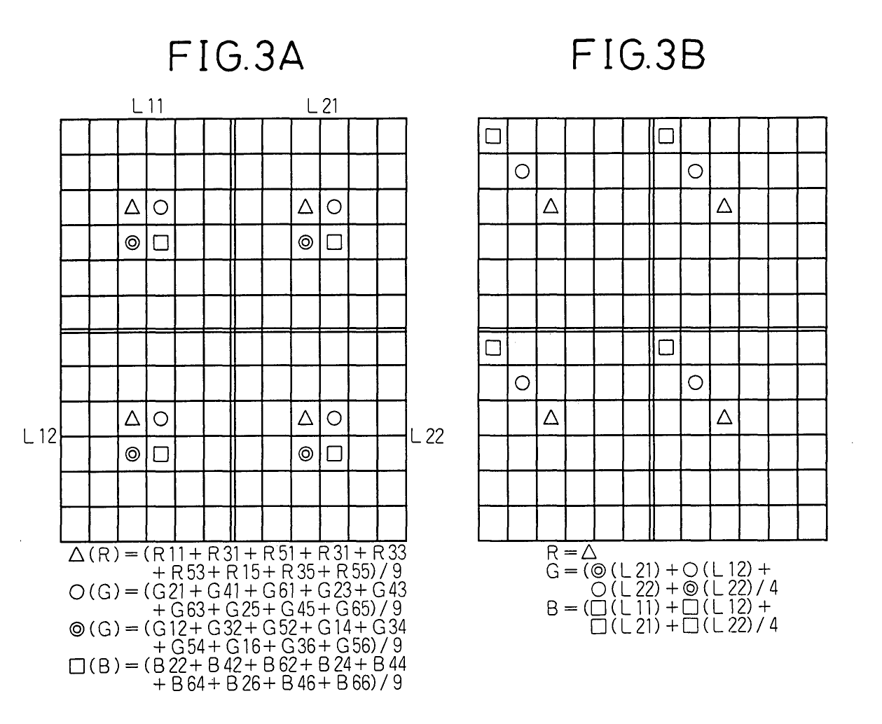

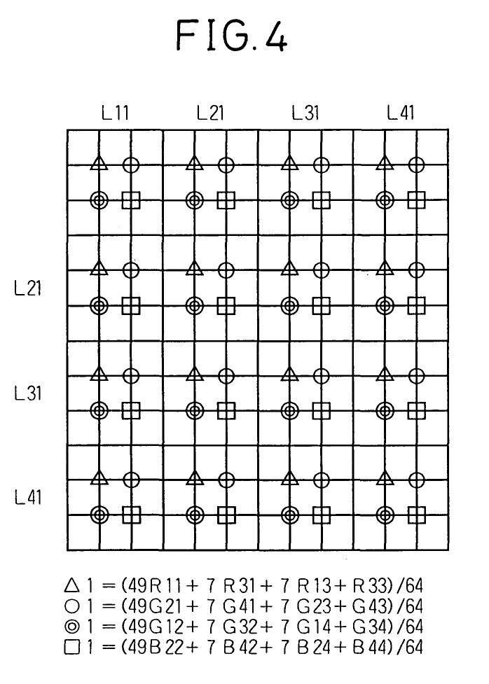

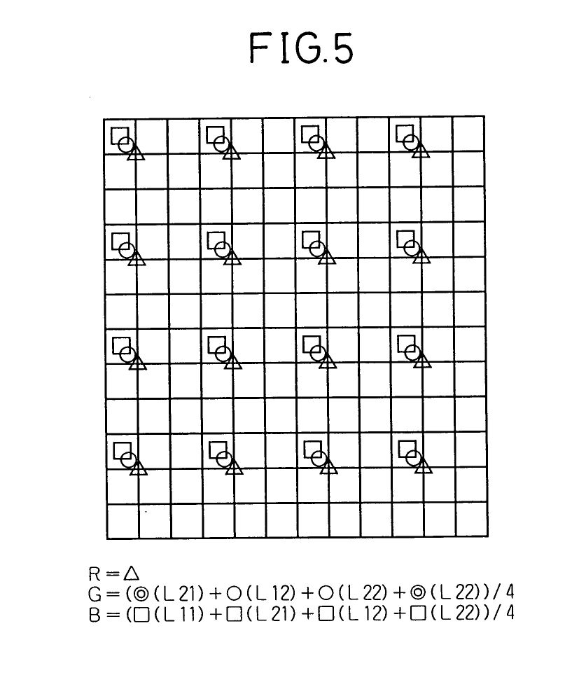

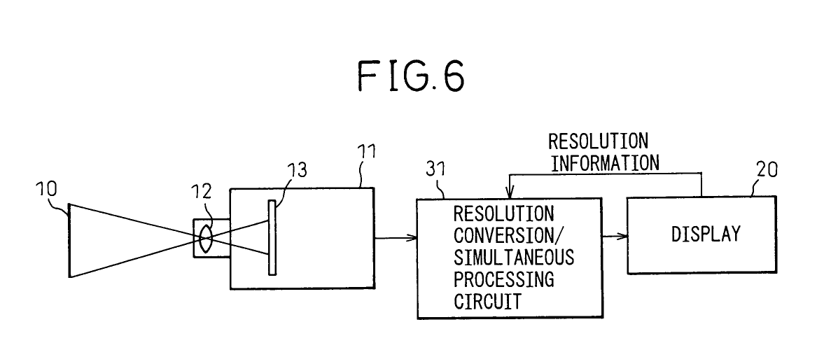

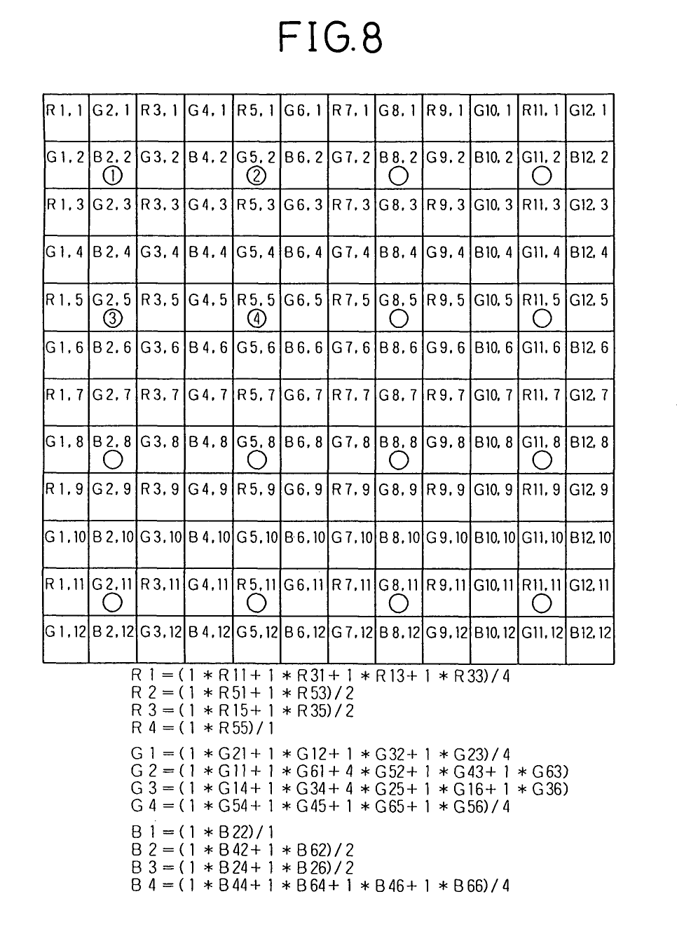

FIG. 8 is a diagram showing processing and operation expressions in the 1-to-⅓ resolution conversion processing unit 43 in the present embodiment. The operation expressions R1, G1 and B1 are those of the pixel data of each color at the position denoted by FIG. 1 in a circle, and the obtained positions of respective colors coincide with each other. This applies to the set of R2, G2 and B2, the set of R3, G3 and B3 and the set of R4, G4 and B4, and other pixel data can be obtained by repeating these. In the conventional example shown in FIG. 3, the 12×12 pixel information mixes with each other, but in the configuration shown in FIG. 8, only 6×6 pixels are used and the pixel positions of respective colors data coincide with each other.

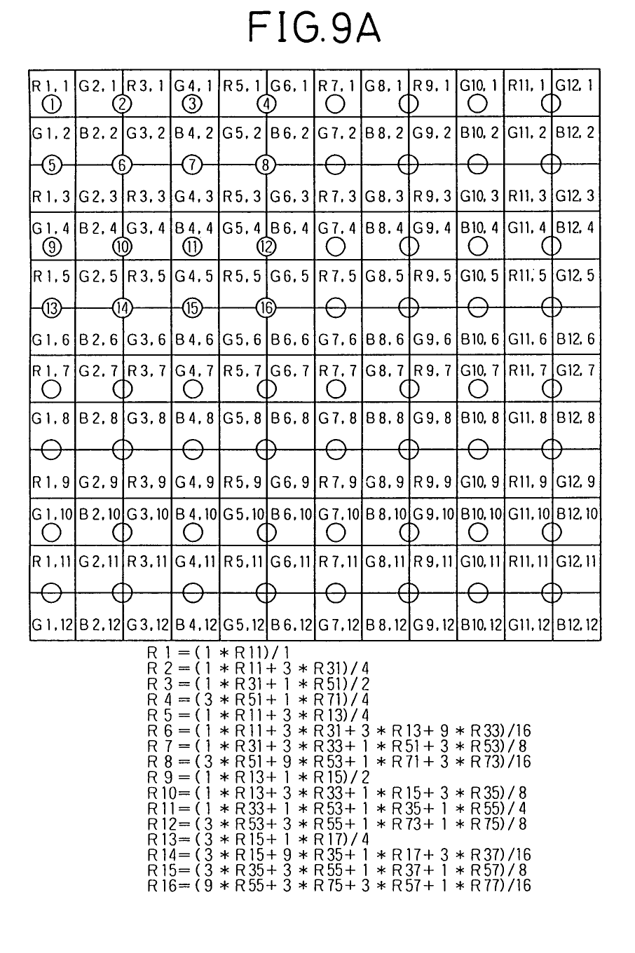

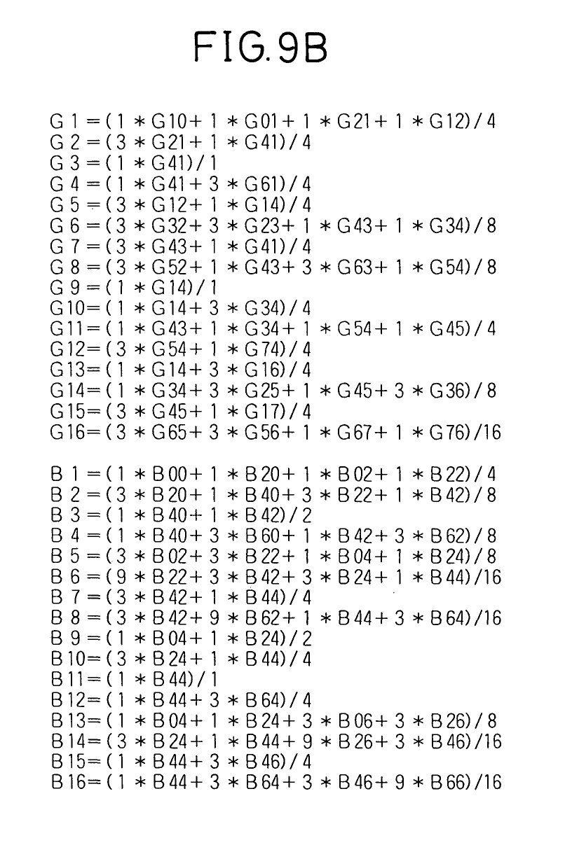

FIG. 9A and FIG. 9B are diagrams showing processing and operation expressions in the 1-to-⅔ resolution conversion processing unit 45 in the present embodiment. The operation expressions R1 to R16, G1 to G16, and B1 to B16 are those of each color pixel data at the position denoted by a figure in a circle and the obtained positions of respective color coincide with each other. Other pixel data can be obtained by repeating these processes.

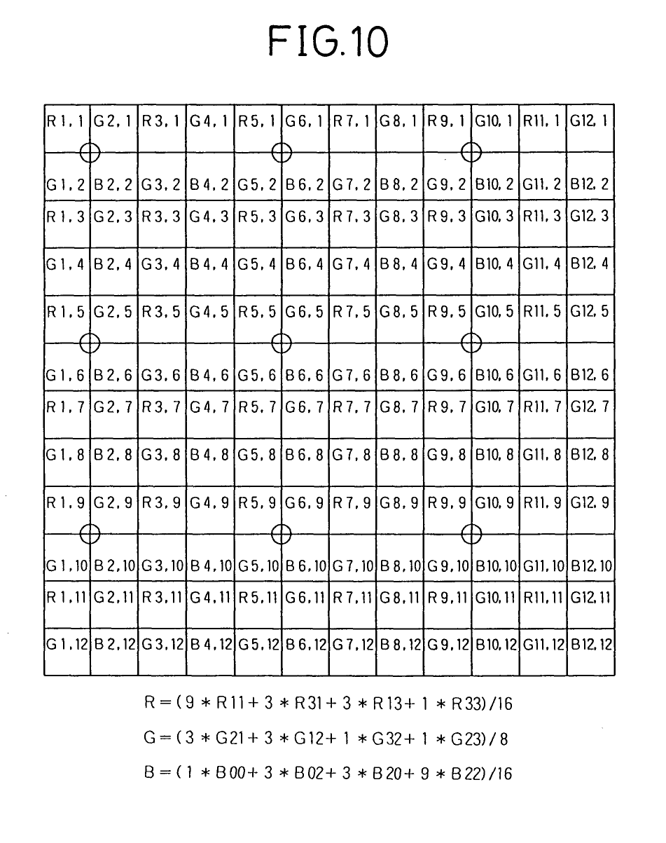

FIG. 10 is a diagram showing processing and operation expressions in the 1-to-¼ resolution conversion processing unit 42 in the present embodiment. The operation expressions R, G and B are those of each color pixel data at the position to the upper-left of a circle and the obtained positions of respective colors coincide with each other. Other pixel data can be obtained by repeating these processes.

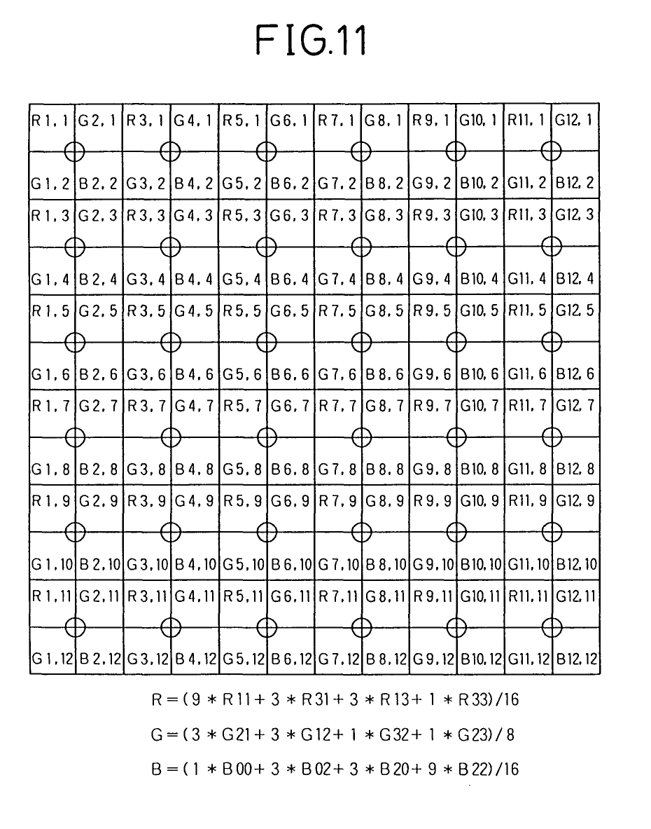

FIG. 11 is a diagram showing processing and operation expressions in the 1-to-½ resolution conversion processing unit 44 in the present embodiment. The operation expressions R, G and B are those of each color pixel data at the position to the upper-left of a circle and the obtained positions of respective colors coincide with each other. Other pixel data can be obtained by repeating these processes.

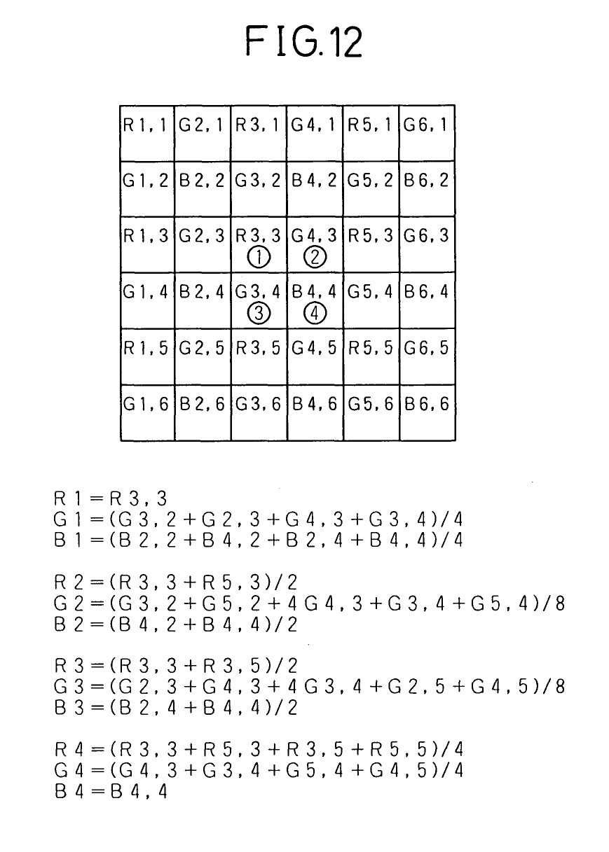

FIG. 12 is a diagram showing processing and operation expressions in the 1-to-1 resolution conversion processing unit 46 in the present embodiment. Resolution is not converted here, but only the simultaneous processing is performed. The operation expressions R1 to R4, G1 to G4, and B1 to B4 are those of each color pixel data at the position denoted by a figure in a circle and the obtained positions of respective colors coincide with each other. Other pixel data can be obtained by repeating these processes.

In accordance with the present invention, as described above, a set of operation expressions is used to perform the resolution conversion processing and simultaneous processing, therefore, they can be performed by a circuit with a simple configuration by sharing the hardware. Moreover, operations are performed on the data before the peripheral required information is thinned, data with high sharpness can be obtained without degradation of resolution and the pixel positions of respective colors can be made to coincide with each other.

We claim:

1. A resolution conversion method for converting color data output from a single-plate-type color-image sensor into data of a predetermined resolution and at the same time, processing the color data so that the pixel positions of respective colors coincide with each other, wherein resolution conversion processing that converts the data of each pixel into data of the predetermined resolution and simultaneous processing that processes the color data so that the pixel positions of respective colors coincide with each other are performed simultaneously in a circuit.

2. The resolution conversion method as set forth in claim 1, wherein the resolution conversion processing and the simultaneous processing perform weighting operations on the color data of pixels including each pixel and neighboring pixels adjacent to said each pixel.

3. The resolution conversion method as set forth in claim 1, wherein plural processes to convert the color data into different resolutions are stored in advance and some of the plural processes are selected and executed according to an external direction.

4. The pixel data processing circuit comprising a resolution conversion/simultaneous processing circuit that converts color data output from a single-plate-type color-image sensor into data of a predetermined resolution directed from the outside and, at the same time, that processes the color data so that the pixel positions of respective colors coincide with each other, wherein the resolution conversion/simultaneous processing circuit performs simultaneously the resolution conversion processing that converts the data of each pixel into data of the predetermined resolution and the simultaneous processing that processes so that the pixel positions of respective colors coincide with each other.

5. The pixel data processing circuit, as set forth in claim 4, wherein the resolution conversion/simultaneous processing circuit performs weighting operations on the color data of pixels including each pixel and neighboring pixels adjacent to said each pixel.

6. The pixel data processing circuit, as set forth in claim 4, wherein the resolution conversion/simultaneous processing circuit stores plural processes to convert the color data into different resolutions and selects and executes some of the plural processes according to a direction from the outside.
